(19) United States
(12) Patent Application Publication
(10) Pub. No.: US 2009/0239086 A1
(43) Pub. Date: Sep. 24, 2009

(54) MICROPHASE-SEPARATED STRUCTURE ON FLEXIBLE SUBSTRATE, AND METHOD OF MANUFACTURE THEREOF

(76) Inventors: Kenichi Ishizuka, Kanagawa (JP); Taisei Nishimi, Kanagawa (JP); Ritsuko Hori, Kanagawa (JP)

Correspondence Address: BIRCH STEWART KOLASCH & BIRCH, PO BOX 747, FALLS CHURCH, VA, 22040-0747, US

(21) Appl. No.: 12/405,628

(22) Filed: Mar. 17, 2009

(30) Foreign Application Priority Data
Mar. 18, 2008 (JP) 2008-069618

(51) Int. Cl. B32B 27/06; B05D 1/36

(52) U.S. Cl. 428/447; 427/407.1

(57) ABSTRACT

A structure having a block copolymer layer with a microphase-separated morphology in which a cylindrical or lamellar phase is oriented perpendicularly to a flexible substrate such as a polymer substrate is provided. The structure includes a flexible substrate and, in order thereon, a metal oxide layer, a layer formed with a silane coupling agent, and a layer which has a microphase-separated morphology and is formed of a block copolymer obtained by bonding two or more mutually incompatible polymer chains. The microphase-separated morphology has one phase which is lamellar or cylindrical, and oriented perpendicularly to the substrate.

### BACKGROUND OF THE INVENTION

The present invention relates to a structure having a metal oxide layer, a layer formed with a silane coupling agent, and a block copolymer layer in this order on a flexible substrate. The invention relates also to a method of manufacturing such a structure.

Recently, in the field of optical materials and electronic materials, there has been a growing demand for greater integration, higher information density, and image information of higher definition. This has led to a need to form a fine, nanometer-scale structure (micropatterning, micropattern structure) in the materials used in this field. In particular, to confer flexibility, handleability and lightweight properties for bendability during use and for lamination onto curved surfaces, there is an acute desire for the high-precision, low-cost manufacture of micropattern structures on flexible substrates such as polymer films.

Micropatterning processes that have been proposed include bottom-up techniques in which a microstructure is manufactured by employing “self-assembly”—i.e., the spontaneous formation of an ordered pattern. Of such techniques, block copolymers formed by bonding two or more different types of polymer chains are known to undergo phase separation at a deca-nanometer level by self-assembly to form a “microphase-separated morphology.” It is believed that, were it possible to orient the cylindrical or lamellar microdomains of such a microphase-separated morphology perpendicular to a flexible substrate, the resulting structures could be adapted for use as, e.g., phase shift films, polarizing films, components for electronic displays, and magnetic recording media, and employed in thus way in a broad range of fields, including energy, the environment and the life sciences.

In general, block copolymer structures (e.g., films) have a microphase-separated morphology with a regular orientation only in narrow regions (such regions are called “grains”) of the structure, and possess overall a microphase-separated morphology of irregular orientation composed of a plurality of aggregated grains. A number of efforts are currently being made to manufacture ordered patterns arrayed in specific directions on flexible substrates. For example, M. Kunz et al. (“Improved technique for cross-sectional imaging of thin polymer films by transmission electron microscopy,” Polymer 34, 2427-2430 (1993)) have vapor-deposited gold onto a polymer substrate, and created thereon a block copolymer film having a lamellar phase-separated morphology. T. Thurn-Albrecht et al. (“Nanoscopic templates from oriented block copolymer films,” Adv. Mater. 12, 787-791 (2000)) have vapor-deposited gold onto a polymer substrate, coated a block copolymer thereon and, by applying an electrical field while heating, have obtained a phase-separated morphology in which cylindrical microdomains are perpendicularly oriented. In addition, JP 3979470 B discloses the creation of a perpendicular cylindrical phase-separated morphology by coating a PET substrate with a block copolymer having a liquid-crystal mesogen on side chains.

However, in the lamellar phase-separated morphology obtained by M. Kunz et al., the lamellar microdomains are oriented horizontally with respect to the substrate; a microphase-separated morphology oriented in the perpendicular direction is not obtained. Also, even though Thurn-Albrecht et al. are able to obtain a cylindrical microphase-separated morphology oriented perpendicularly with respect to a polymer substrate, achieving this effect requires the application of an electrical field. In a process where such an electrical field is applied, the number of operations (e.g., forming electrodes, applying voltage) increases, creating a need for a larger apparatus. Moreover, such a process is difficult to carry out over a large surface area and is thus undesirable in terms of productivity. Finally, in JP 3979470 B, because the block copolymer used is required to have a special structure, this approach lacks general versatility and applicability to other polymers is limited. Because sufficient study has yet to be done on controlling the orientation of the microphase-separated morphology, it has been difficult to manufacture, at low cost and over a large surface area, microphase-separated morphologies in which the microdomains are oriented perpendicularly on a flexible substrate such as a polymer substrate.

### SUMMARY OF THE INVENTION

It is therefore an object of the present invention to provide a structure having a block copolymer layer with a microphase-separated morphology in which a cylindrical or lamellar phase is oriented perpendicularly to a flexible substrate such as a polymer substrate. Another object of the invention is to provide a method capable of manufacturing such a structure at low cost and over a large surface area.

The inventors have discovered that, by inserting a layer having specific qualities between a flexible substrate such as a polymer substrate and a block copolymer layer, a block copolymer layer having an oriented structure that is ordered can be obtained more easily than by conventional methods.

That is, the inventors have found that the above objects of the invention are resolved by the following structures and method.
(1) A structure including a flexible substrate and, in order thereon, a metal oxide layer, a layer formed with a silane coupling agent, and a layer which has a microphase-separated morphology and is formed of a block copolymer obtained by bonding two or more mutually incompatible polymer chains; wherein the microphase-separated morphology has one phase which is lamellar or cylindrical, and oriented perpendicularly to the substrate.
(2) The structure of (1), wherein the layer formed with the silane coupling agent has a film thickness which is at least equal to a surface roughness of the metal oxide layer.
(3) The structure of (1), wherein the silane coupling agent has general formula (1) below

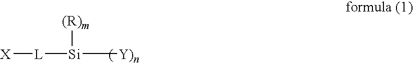

where X is a functional group, L is a linkage group or merely a bond, R is a hydrogen atom or an alkyl of 1 to 6 carbons, Y is a hydrolyzable group, and the letter m is an integer from 0 to 2 and the letter n is an integer from 1 to 3, such that n+m=3.
(4) The structure of (1), wherein the metal oxide layer is composed of an oxide of a metal selected from the group consisting of silicon, aluminum, silver, copper, iron, nickel, lead, indium, chromium, tin, titanium, zinc, gallium, bismuth and zirconium.
(5) A method of manufacturing the structure of (1), including the steps of: forming a metal oxide layer on a flexible substrate; forming a layer with a silane coupling agent on the metal oxide layer; and forming a block copolymer layer on the layer formed with the silane coupling agent.

Accordingly, the present invention provides a structure having a block copolymer layer with a microphase-separated morphology in which a cylindrical or lamellar phase is oriented perpendicularly to a flexible substrate such as a polymer substrate. The invention also provides a method which is capable of manufacturing such a structure at a low cost and to a large surface area.

### BRIEF DESCRIPTION OF THE DRAWINGS

In the accompanying drawings:

FIG. 1A is a perspective, cross-sectional view showing a structure having a cylindrical microphase-separated morphology according to one embodiment of the invention, and FIG. 1B is a top view of the same;

FIG. 2A is a perspective, cross-sectional view showing a structure having a lamellar microphase-separated morphology according to another embodiment of the invention, and FIG. 2B is a top view of the same;

FIG. 3A is a perspective, cross-sectional view showing a structure having a cylindrical microphase-separated morphology according to yet another embodiment of the invention, and FIG. 3B is a top view of the same;

FIG. 4A is a perspective, cross-sectional view showing a structure having a lamellar microphase-separated morphology according to a further embodiment of the invention, and FIG. 4B is a top view of the same;

FIG. 5A is an atomic force microscopic image taken from the top side of a specimen A, and FIG. 5B is a transmission electron micrograph of a section of specimen A;

FIG. 6A is an atomic force microscopic image taken from the top side of a specimen B, and FIG. 6B is a transmission electron micrograph of a section of specimen B;

FIG. 7 is an atomic force microscopic image taken from the top side of a specimen C;

FIG. 8A is an atomic force microscopic image taken from the top side of a specimen D, and FIG. 8B is a transmission electron micrograph of a section of specimen D;

FIG. 9 is an atomic force microscopic image taken from the top side of a specimen E;

FIG. 10 is an atomic force microscopic image taken from the top side of a specimen F;

FIG. 11 is an atomic force microscopic image taken from the top side of a specimen G;

FIG. 12 is an atomic force microscopic image taken from the top side of a specimen H;

FIG. 13 is an atomic force microscopic image taken from the top side of a specimen J;

### DETAILED DESCRIPTION OF THE INVENTION

Specific embodiments of the invention are described below.

The structure (also referred to herein as a “structural body”) of the present invention is composed of a flexible base having in order thereon: a metal oxide layer, a layer formed with a silane coupling agent, and a layer which has a microphase-separated morphology and is formed of a block copolymer obtained by bonding two or more mutually incompatible polymer chains. One phase of the microphase-separated morphology is lamellar or cylindrical and is oriented perpendicularly to the substrate.

The inventive structure is manufactured primarily by the following three steps:
(Step 1) forming a metal oxide layer on a flexible substrate;
(Step 2) forming a layer with a silane coupling agent on the metal oxide layer; and
(Step 3) forming a block copolymer layer on the layer formed with the silane coupling agent.

Each of these steps and the materials used therein are described in detail below.

### Step 1

Step 1 is the step of forming a metal oxide layer on a flexible substrate. The materials used in this step and the method of forming the layer are described below.

### Flexible Substrate

The flexible substrate used in the invention is not subject to any particular limitation. For example, a commonly used polymer substrate (film, etc.) may be suitably employed for this purpose. Illustrative examples include polymer substrates of polyimide (PI), polyethersulfone (PES), polymethyl methacrylate (PMMA), polycarbonate (PC), cycloolefin polymer (COP), polyethylene naphthalate (PEN), polyethylene terephthalate (PET), polypropylene (PP), liquid-crystal polymer (LCP) and polydimethylsiloxane (PDMS); and metal films such as aluminum foil. Of these, polymer substrates are preferred on account of their easy processability and good handleability. Polyimide films are especially preferred because their high heat resistance, excellent solvent resistance and good mechanical strength.

These flexible substrates may optionally be subjected to, for example, a known corona discharge treatment in order to strengthen their adhesion to the subsequently described metal oxide layer.

### Metal Oxide Layer

The metal oxide making up the metal oxide layer of the invention may be the oxide of a metal such as iron, nickel, lead, chromium, bismuth, gold, platinum, silver, copper, silicon, aluminum, indium, titanium, zinc, zirconium, tin, magnesium, germanium, tungsten, manganese, gallium and arsenic. These may be used singly or as combinations of two or more thereof. Illustrative examples of suitable metal oxides include silicon dioxide (SiO₂), aluminum oxide (Al₂O₃), titanium oxide (TiO₂), indium-tin oxide (ITO), zirconium oxide (ZrO₂), magnesium oxide (MgO), tin oxide (SnO₂), nickel oxide (NiO), germanium dioxide (GeO₂), copper oxide (CuO), iron oxide (Fe₂O₃), and mixtures thereof. Of these, oxides of metals selected from the group consisting of silicon, aluminum, silver, copper, iron, nickel, lead, indium, chromium, tin, titanium, zinc, gallium, bismuth and zirconium are preferred. From the standpoint of handleability and availability, SiO₂, Al₂O₃, ITO, CuO and Fe₂O₃ are especially preferred.

The method of forming the metal oxide layer on the flexible substrate includes, but is not particularly limited to, physical vapor deposition processes such as vacuum evaporation and sputtering, chemical vapor deposition processes, and plating. A vacuum evaporation or sputtering process is preferable on account of the ease of controlling such properties as the thickness and density of the layer obtained. The metal oxide layer in the present invention may be a monolayer formed by one of the above-mentioned material, a monolayer made of two or more of the above materials, or a multilayer formed by stacking a plurality of such monolayers.

The metal oxide layer of the invention may have layered structure composed of a metal layer and a metal oxide layer formed on the metal layer. Illustrative examples of the metal layer include layers made of at least one metal selected from the group consisting of iron, nickel, lead, chromium, bismuth, gold, platinum, silver, copper, silicon, aluminum, indium, titanium, zinc, zirconium, tin, magnesium, germanium, tungsten, manganese and gallium. Of these, gold, platinum, silver, copper, iron, indium, titanium, zinc and chromium are preferred. The metal layer may be a single layer or may have a layered structure consisting of two or more layers.

The method of forming a metal oxide layer having such a layered structure is not subject to any particular limitation. A known method may be used for this purpose. Illustrative examples include a method that involves depositing a metal layer on a substrate and leaving the metal layer exposed to the air so as to induce oxidation of the surface and thereby form a metal oxide layer (native oxide film), and a method that involves depositing a metal layer on a substrate by vacuum evaporation or sputtering, then depositing on the metal layer a metal oxide layer (e.g., a layer of SiO₂) by vacuum evaporation or sputtering.

In cases where the metal oxide layer is a layered structure having a metal layer, because the metal layer functions as an electrically conductive layer, the structure of the invention can be advantageously used in such applications as anisotropic electrically conductive films, anisotropic electron transporting films, anisotropic hole transporting films, anisotropic thermally conductive films and anisotropic ion-conductive films.

The thickness of the metal oxide layer may be set as appropriate for the intended use of the inventive structure, although a thickness of from 5 to 1,000 nm is desirable. More specifically, when the surface of the polymer substrate is to be coated with SiO₂ or SiO by vacuum evaporation, the thickness of the metal oxide layer is preferably from 10 nm to 500 nm, and more preferably from 10 to 100 nm. If the metal oxide layer is too thin, the surface of the polymer substrate cannot be covered completely and uniformly. On the other hand, if the metal oxide layer is too thick, cracking or separation will occur between the substrate and the metal oxide layer. Neither situation is desirable.

When the metal oxide layer forms a layered structure together with the above-described metal layer, the thickness of each layer may be suitably selected according to the intended use. In particular, the metal oxide layer has a thickness of preferably from 10 to 500 nm, and more preferably from 10 to 50 nm; and the metal layer has a thickness of preferably from 10 to 500 nm, and more preferably from 10 to 100 nm.

To enable the subsequently described layer formed with a silane coupling agent to be more uniformly fabricated, it is advantageous for the metal oxide layer formed on the flexible substrate to be as smooth as possible (i.e., to have a surface roughness of 0). The surface roughness is typically 5 nm or less, and preferably 2 nm or less. As used herein, “roughness” refers to the roughness Ra (mean surface roughness) value determined by conducting a roughness analysis on atomic force microscope topographic images measured with a conventional, commercially available atomic force microscope (also abbreviated below as “AFM”).

### Step 2

Step 2 is the step of forming a layer with a silane coupling agent on the metal oxide layer obtained in Step 1. The silane coupling agent used in Step 2 and the method of forming this layer are described below.

### Silane Coupling Agent

The silane coupling agent used in the present invention reacts with the above-described metal oxide layer, causing the formation of silicon-oxygen-silicon covalent bonds with the metal oxide layer, as a result of which a layer is formed by the silane coupling agent. The type of silane coupling agent is suitably selected. However, to further increase the orderliness of the microphase-separated morphology of the subsequently described block copolymer layer, preferred use may be made of a silane coupling agent of general formula (1) below.

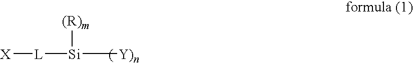

In the above formula, X is a functional group, L is a linkage group or merely a bond, R is a hydrogen atom or an alkyl of 1 to 6 carbons, and Y is a hydrolyzable group. Also, the letter m is an integer from 0 to 2 and the letter n is an integer from 1 to 3, such that n+m=3.

In general formula (1), X is a functional group, illustrative examples of which include amino, carboxyl, hydroxyl, aldehyde, thiol, isocyanate, isothiocyanate, epoxy, cyano, dimethylamino, diethylamino, hydrazino, hydrazide, vinylsulfone, vinyl, alkyl (having preferably from 1 to 20 carbons, and more preferably from 6 to 18 carbons) and alkoxy groups, and hydrogen atoms.

In general formula (1), R is a hydrogen atom or an alkyl of 1 to 6 carbons. Of these, methyl and ethyl are preferred. In cases where there are a plurality of R moieties in general formula (1), the R moieties may be the same or different.

In general formula (1), Y is a hydrolyzable group. Illustrative examples include alkoxy groups (e.g., methoxy, ethoxy), halogen atoms (e.g., fluorine, chlorine, bromine, iodine), and acyloxy groups (e.g., acetoxy, propanoyloxy). Of these, methoxy groups, ethoxy groups and chlorine atoms are preferred because of the good reactivity they confer.

In general formula (1), L is a linkage group or merely a bond. Illustrative examples include alkylene groups (preferably having from 1 to 20 carbons), —O—, —S—, arylene groups, —CO—, —NH—, —SO₂—, —COO—, —CONH— and groups that are combinations thereof. Of these, alkylene groups are preferred. In cases where L represents merely a bond, the X moiety in general formula (1) is directly linked to silicon.

In general formula (1), the letter m is an integer from 0 to 2 and the letter n is an integer from 1 to 3, such that n+m=3. The letter m is preferably 1 or 2, and the letter n is preferably 1 or 2.

Illustrative, non-limiting, examples of the silane coupling agent used in the invention include octadecyltrimethoxysilane, ethyldimethylchlorosilane, dimethylaminopropyltrimethoxysilane, diethylaminopropyltrimethoxysilane, chlorotrimethylsilane, dichlorodimethylsilane, phenyldimethylchlorosilane, perfluorodecyltriethoxysilane, p-methoxyphenylpropylmethyldichlorosilane, γ-aminopropyltrimethoxysilane, N-β(aminoethyl)-γ-aminopropyltrimethoxysilane, γ-aminopropylmethyldiethoxysilane, γ-mercaptopropyltrimethoxysilane and γ-glycidoxypropyltriethoxysilane.

No particular limitation is imposed on the method of forming a layer with the silane coupling agent on the metal oxide layer. For example, the methods described in the book entitled Shiran kappuringu-zai no kōka to shiyōhō [Silane coupling agents: effects and uses] (Y. Nakamura, ed.; published on Jun. 20, 2006 by Science & Technology Co., Ltd.) may be used for this purpose. Specific examples include methods in which the silane coupling agent is coated, either directly as is or after dissolution in a solvent, onto the metal oxide layer; and methods in which the substrate on which the metal oxide layer has been deposited is immersed in a solution containing the silane coupling agent. The reaction time and temperature are selected as appropriate for the method and the silane coupling agent which are used. Following treatment with the silane coupling agent, if necessary, rinsing with a solvent may be carried out.

The layer formed with a silane coupling agent which has been obtained in the above-described step presumably serves to mitigate the influence of the metal oxide layer surface roughness, and preferably has a thickness which is at least equal to the surface roughness Ra of the metal oxide layer. The layer formed with the silane coupling agent can be made thicker by using a silane coupling agent having a long molecular chain, and can be made thinner by using a silane coupling agent having a short molecular chain. The layer thickness can be measured by a technique such as cross-sectional transmission electron microscopic analysis. A simple method that may be used for estimating the layer thickness is molecular computation with a program such as MOPAC (e.g., WinMOPAC (Ver. 3.9.0)).

As mentioned above, the thickness of the layer formed with the silane coupling agent is at least equal to the surface roughness of the metal oxide layer. Specifically, the thickness is preferably from 0.5 to 10 nm, more preferably from 1 to 5 nm, and most preferably from 2 to 5 nm. Within the above range, a cylindrical or lamellar microphase-separated morphology having a more ordered array can be obtained.

The layer formed with a silane coupling agent which has been obtained in the above-described step has a contact angle with water that can be controlled by means of, for example, the silane coupling agent used. A suitable and optimal value is selected based on the type of block copolymer described subsequently. To obtain a micropattern having a greater degree of order, the contact angle is preferably from 50 to 120°, and more preferably from 55 to 115°. “Contact angle” refers herein to the static contact angle, which is measured by the sessile drop method at 22° C. using a contact goniometer. As used herein, “static contact angle” refers to the contact angle under conditions where flow and other changes in state associated with time do not arise.

To enable a more highly ordered micropattern to be obtained, it is desirable for the layer formed with a silane coupling agent which has been obtained in the above-described step to have surface tensions with the respective components (blocks) of the block copolymer which differ therebetween by preferably from 0 to 6 mN/m, and more preferably from 0 to 3 mN/m. The difference between the surface tensions with the respective components of the block copolymer is obtained as follows. The contact angles of each component, and of the substrate used (the surface-modified substrate on which the layer formed with a silane coupling agent has been deposited), with three types of liquids—tetradecane, methylene iodide and water—are measured, and the surface free energies are derived. Next, the surface tension of each component with the substrate (the surface-modified substrate) is computed, then the difference between these surface tensions is computed.

### Step 3

Step 3 is the step of forming a block copolymer layer on the layer formed with a silane coupling agent which was obtained in Step 2. The type of block copolymer used in this step and the method of forming the layer are described below.

### Block Copolymer

The term ‘block copolymer’ generally refers to a copolymer in which a plurality of types of homopolymer chain are bonded to each other as blocks (components). For example, there are polymers in which a polymer A chain composed of monomer A repeating units and a polymer B chain composed of monomer B repeating units are bonded together at their respective ends. Block copolymers are known to differ from random copolymers in that, for example, they form a structure wherein a phase A of aggregated polymer A chains and a phase B of aggregated polymer B chains are spatially separated (microphase-separated morphology). In the phase separation (macrophase separation) obtained with ordinary polymer blends, because two types of polymer chains can be completely separated, complete separation into two phases is ultimately achieved, resulting in a unit cell size of at least 1 μm. By contrast, the unit cells in microphase-separated morphologies that can be obtained with a block copolymer have a size on the order of from several nanometers to several deca-nanometers. Moreover, depending on the composition of the blocks therein, the microphase-separated morphologies are known to exhibit a variety of configurations, such as spherical micellar, cylindrical or lamellar morphologies.

The block copolymer used in the present invention is composed of two or more types of polymers that are mutually incompatible, and may be in the form of any one of the following: a diblock copolymer, a triblock copolymer or a multiblock copolymer. Specifically, referring to portions composed of polymer A and portions composed of polymer B as, respectively, “A blocks” and “B blocks,” exemplary block copolymers include A-B type block copolymers which have an -A-B- structure and are composed of one A block bonded with one B block, A-B-A type block copolymers which have an -A-B-A- structure and are composed of A blocks bonded to both ends of a B block, and B-A-B type block copolymers which have a -B-A-B- structure and are composed of B blocks bonded to both ends of an A block. In addition, use may also be made of block copolymers which have a -(A-B)ₙ- structure and are composed of a plurality of A blocks and B blocks. Of these, from the standpoint of availability and ease of synthesis, A-B type block copolymers (diblock copolymers) are preferred. The chemical bonds connecting the polymers to each other are preferably covalent bonds.

Illustrative examples of the polymers which make up the block copolymer used in the invention include vinyl polymers such as polystyrene, polymethylstyrene, polydimethylstyrene, polytrimethylstyrene, polyethylstyrene, polyisopropylstyrene, polychloromethylstyrene, polymethoxystyrene, polyacetoxystyrene, polychlorostyrene, polydichlorostyrene, polybromostyrene, polytrifluoromethylstyrene, polymethyl methacrylate, polyethyl methacrylate, polybutyl methacrylate, polyisobutyl methacrylate, polyhexyl methacrylate, poly(2-ethylhexyl methacrylate), polyisodecyl methacrylate, polylauryl methacrylate, polyphenyl methacrylate, polymethoxyethyl methacrylate, polymethyl acrylate, polyethyl acrylate, polybutyl acrylate, polyhexyl acrylate, poly(2-ethylhexyl acrylate), polyphenyl acrylate, polymethoxyethyl acrylate, polyglycidyl acrylate, polyvinyl acetate, polyvinyl propionate, polyvinyl butyrate, polyvinyl isobutyrate, polyvinyl caproate, polyvinyl chloroacetate, polyvinyl methoxyacetate, polyvinyl phenyl acetate, polyethylene, polypropylene, polyisobutylene, polyvinyl chloride, polyvinylidene chloride, polytetrafluoroethylene and polyvinylidene fluoride; diene polymers such as polybutadiene and polyisoprene; ether polymers such as polymethylene oxide, polyethylene oxide, polythioether, polydimethylsiloxane and polyethersulfone; ester-based condensation polymers such as poly(ε-caprolactone) and polylactic acid; and amide-based condensation polymers such as nylon 6, nylon 66, poly(m-phenylene isophthalamide), poly(p-phenylene terephthalamide) and polypyromellitimide. The combination of polymer chains making up the block copolymer is not subject to any particular limitation, provided the polymer chains used are mutually incompatible. For example, combinations of different vinyl copolymers, a vinyl polymer with a diene polymer, a vinyl polymer with an ether polymer, a vinyl polymer with an ester-based condensation polymer, or different diene polymers are preferred. The use of one or more vinyl polymer is more preferred. The use of a combination of different vinyl polymers is most preferred.

Specific examples include polystyrene/polymethyl methacrylate, polystyrene/polyethylene glycol, polyisoprene/poly(2-vinylpyridine), polymethyl acrylate/polystyrene, polybutadiene/polystyrene, polyisoprene/polystyrene, polystyrene/poly(2-vinylpyridine), polystyrene/poly(4-vinylpyridine), polystyrene/polydimethylsiloxane, polybutadiene/polyethylene oxide and polystyrene/polyacrylic acid. Of these, from the standpoint of availability and versatility, polystyrene-containing block copolymers such as polystyrene/polymethyl methacrylate, polystyrene/polyethylene glycol, polyisoprene/polystyrene, polystyrene/poly(2-vinylpyridine), polystyrene/poly(4-vinylpyridine) and polybutadiene/polyethylene oxide are preferred.

The block copolymer in the present invention is preferably one in which the mutually incompatible polymer block chains making up the block copolymer have a large difference in polarity. The polarity difference can be numerically expressed as, for example, the solubility parameter difference (SP difference). The solubility parameter can be estimated from the molecular structure. Numerous methods for calculating the theoretical solubility parameter have been proposed, including those of Small, Hoy and Fedors. Of these, Fedors theoretical solubility parameter does not require the polymer density parameter, and thus is an effective method of calculation also for polymers having a novel structure (Nippon Setchaku Kyokaishi 22, No. 10, 564-567 (1986)). In Fedors method of calculation, the theoretical solubility parameter (units: (cal/cm³)^{1/2}) can be determined by Formula 2 below using the bond energy and energy of molecular motion Δei possessed by the atoms or atomic groups such as polar radicals making up the polymer, the bond energy and energy of molecular motion ΣΔei of repeating units making up the polymer, the occupied volume Δvi of atoms or atomic groups such as polar radicals making up the polymer, and the occupied volume ΣΔvi of repeating units making up the polymer.

SP=(ΣΔei/ΣΔvi)^{1/2} Formula 2

For example, the theoretical solubility parameter for polystyrene is estimated to be 14.09 (cal/cm³)^{1/2}, and the theoretical solubility parameter for polymethyl methacrylate is estimated to be 10.55 (cal/cm³)^{1/2}. Therefore, the polarity difference (SP difference) in a block copolymer composed of a polystyrene block chain and a polymethyl methacrylate block chain is 3.54 (cal/cm³)^{1/2}.

The weight-average molecular weight (Mw) of the block copolymer according to the present invention is suitably selected according to the intended use, and is preferably at least 1×10⁴, more preferably from 1×10⁴ to 1×10⁷, and even more preferably from 5×10⁴ to 1×10⁶. This weight-average molecular weight (Mw) is the polystyrene-equivalent weight-average molecular weight obtained following measurement by gel permeation chromatography (GPC).

The block copolymer of the present invention preferably has a narrow molecular weight distribution. Specifically, the molecular weight distribution (Mw/Mn) expressed in terms of the weight-average molecular weight (Mw) and the number-average molecular weight (Mn) is preferably from 1.00 to 1.50, and more preferably from 1.00 to 1.15. By having the Mw/Mn value fall within the above range, a microphase-separated morphology of more uniform size can be formed.

The copolymerization ratio of the block copolymer in the invention is suitably selected so as to enable a cylindrical or lamellar microphase-separated morphology to be obtained. For example, in the case of a cylindrical microphase-separated morphology composed of a diblock copolymer (A-B type) or a triblock copolymer (A-B-A type), the volumetric ratio between polymer A and polymer B which make up the copolymer (polymer A/polymer B) is preferably from 0.9/0.1 to 0.65/0.35 or from 0.35/0.65 to 0.1/0.9, and more preferably from 0.8/0.2 to 0.7/0.3 or from 0.3/0.7 to 0.2/0.8. In the case of a similarly composed lamellar microphase-separated morphology, the volumetric ratio between polymer A and polymer B which make up the copolymer (polymer A/polymer B) is preferably from 0.65/0.35 to 0.35/0.65, and more preferably from 0.6/0.4 to 0.4/0.6. Within the above ranges, a cylindrical or lamellar microphase-separated morphology having a more ordered array can be obtained.

The block copolymer of the invention may be synthesized by a known method. Examples of methods that may be employed for this purpose include living anionic polymerization, living cationic polymerization, living radical polymerization, group transfer polymerization and ring-opening metathesis polymerization. More specific examples include living polymerization processes which use various types of monomers and carry out polymerization from the ends of the polymer chain (anionic polymerization, cationic polymerization, living radical polymerization), living polymerization processes in which synthesis takes place from the center of the polymer chain (anionic polymerization), and synthesis processes which involve bonding the ends of end-functional polymers (anionic polymerization, living radical polymerization).

The method of forming a block copolymer layer on the layer formed with the silane coupling agent is not subject to any particular limitation. However, from the standpoint of the ease of controlling layer thickness, a method which involves coating a block copolymer-containing solution is preferred. The coating method is not subject to any particular limitation. Common coating methods which may be used include spin coating, solvent casting, dip coating, roll coating, curtain coating, slide coating, extrusion coating, bar coating and gravure coating. From the standpoint of productivity and other considerations, spin coating is preferred. The spin coating conditions are suitably selected according to the block copolymer used. After coating, a drying step may be carried out if necessary. The drying conditions for solvent removal are suitably selected according to the substrate employed and the block copolymer used, although it is preferable to carry out such treatment at a temperature of from 20 to 200° C. for a period of from 0.5 to 336 hours. The drying temperature is more preferably from 20 to 180° C., and even more preferably from 20 to 160° C. Such drying treatment may be carried out in several divided stages. This drying treatment is most preferably carried out in a nitrogen atmosphere, in low-concentration oxygen or at an atmospheric pressure of 10 torr or less.

The solvent used to prepare the block copolymer-containing solution should be one that dissolves the block copolymer, and is selected as appropriate for both types of polymer used. Illustrative examples include toluene, chloroform, dichloromethane, dimethylformamide, dimethylacetamide, dimethylsulfoxide, tetrahydrofuran, 1,4-dioxane, acetone, diethylketone, methyl ethyl ketone, methyl isobutyl ketone, isopropanol, ethanol, methanol, hexane, octane, tetradecane, cyclohexane, cyclohexanone, acetic acid, ethyl acetate, methyl acetate, pyridine, N-methylpyrrolidone and water. Of these, toluene, chloroform, dichloromethane, dimethylformamide and methyl ethyl ketone are preferred. The concentration of the block copolymer in the solution is preferably from 0.100 to 20.0 wt %, and more preferably from 0.250 to 15.0 wt %. Within this range, the solution is easy to handle during coating and a uniform film can readily be obtained.

The average thickness of the block copolymer layer obtained in the above step may be suitably controlled by varying, for example, the concentration of the block copolymer used, although the thickness is preferably from 10 to 2,000 nm, and more preferably from 50 to 1,000 nm. Within this range, the orderliness of the resulting microphase-separated morphology is further enhanced. The layer thickness is obtained by taking measurements at three random points on the film surface with a suitable known apparatus such as a profiler (KLA-Tencor Corp.), and calculating the arithmetical mean of the measurements.

Preferred embodiments of the combination of the above-described silane coupling agent with the block copolymer include cases in which the silane coupling agent is one where, in general formula (1), X is an alkyl, alkoxy, dimethylamino or diethylamino group and L is an alkylene group, an arylene group, —O—, —S—, —CO—, —NH—, —SO₂—, —COO—, —CONH— or a combination thereof (specific examples of such silane coupling agents being octadecyltrimethoxysilane, methoxyphenylpropylmethyldichlorosilane, ethyldimethylchlorosilane, diethylaminopropyltrimethoxysilane and dimethylaminopropyltrimethoxysilane); and the block copolymer is a polystyrene-containing copolymer such as polystyrene/polymethyl methacrylate or polystyrene/polyethylene oxide, or is a polymethyl methacrylate-containing copolymer such as polymethyl methacrylate/polyethylene oxide or polymethyl methacrylate/polyisoprene. With such combinations, microphase-separated morphologies having a higher degree of order can be obtained.

Following the completion of Step 3, if necessary, the multilayer body obtained in Step 3 may be subjected to heat treatment (heating step). The heating temperature and time are suitably set in accordance with the block copolymer used and the layer thickness, although heating is generally carried out at or above the glass transition temperature of the block copolymer. The heating temperature may typically be set in a range of from 60 to 300° C., although a temperature of from 80 to 270° C. is preferred based on the glass transition temperature of the monomer units making up the block copolymer. A heating time of at least one minute is suitable, although a heating time of from 10 to 1,440 minutes is preferred. To prevent oxidative degradation of the block copolymer film by heating, heating is preferably carried out in an inert atmosphere or a vacuum.

Following the completion of Step 3, if necessary, the multilayer body obtained in Step 3 may be treated by exposure within an organic solvent vapor atmosphere (solvent treatment step). The organic solvent employed for this purpose is suitably selected according to the block copolymer used. Preferred examples include benzene, toluene, xylene, acetone, methyl ethyl ketone, chloroform, methylene chloride, tetrahydrofuran, dioxane, hexane, octane, methanol, ethanol, acetic acid, ethyl acetate, diethyl ether, carbon disulfide, dimethylformamide and dimethylacetamide. Of these, toluene, xylene, acetone, methyl ethyl ketone, chloroform, tetrahydrofuran and dioxane are preferred. Toluene, methyl ethyl ketone, chloroform and dioxane are more preferred.

### Microphase-Separated Morphology

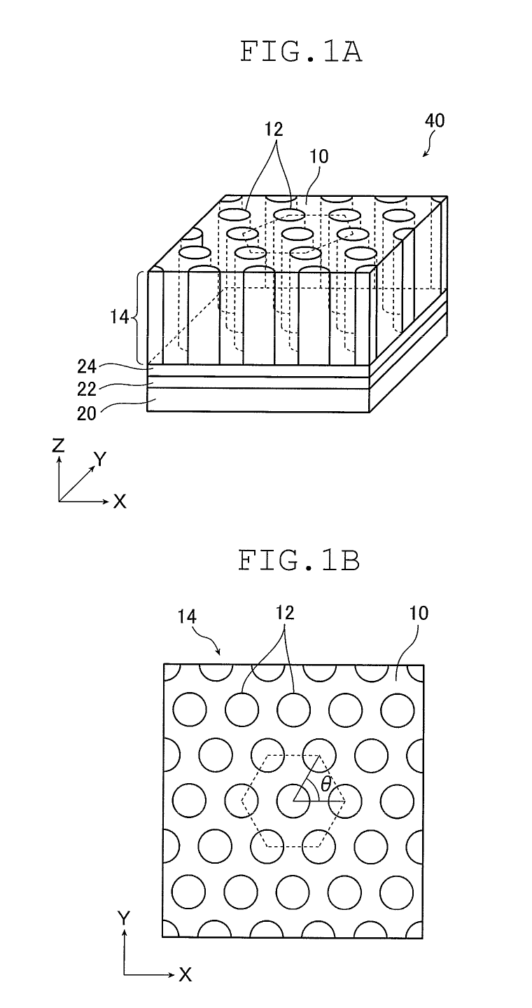

The block copolymer layer obtained in the above-described step forms a microphase-separated morphology in which a cylindrical or lamellar phase (collectively referred to below as “microdomains”) is oriented perpendicularly to the substrate. By way of illustration, FIG. 1 shows a schematic diagram of a structure having a cylindrical microphase-separated morphology obtained using a diblock copolymer (in which a polymer A and a polymer B are bonded at the ends thereof). “Cylindrical microphase-separated morphology” refers herein to a structure in which one of the separated phases is cylindrical. It should be noted that the flexible substrate 20, the metal oxide layer 22, and the layer 24 formed with a silane coupling agent are not limited to the relative thicknesses shown in FIG. 1.

As shown in FIG. 1, the block copolymer layer 14 has a microphase-separated morphology composed of a continuous phase 10 and cylindrical microdomains 12 distributed within the continuous phase 10, and is situated on the surface of the flexible substrate 20. The continuous phase 10 and the cylindrical microdomains 12 are respectively formed of the polymer A and the polymer B which make up the block copolymer. The cylindrical microdomains 12 are distributed within the continuous phase 10 and oriented substantially perpendicular to the flexible substrate 20 in the Z-axis direction in FIG. 1A. As shown in FIG. 1B, the cylindrical microdomains 12 preferably have a zigzag arrangement in the horizontal plane of the applied film (the plane XY in the diagram), and most preferably form an ordered array having a hexagonal lattice-like pattern. Here, “hexagonal lattice-like” denotes a structure in which the angle θ between one microdomain and two adjacent microdomains is substantially 60 degrees (where “substantially 60 degrees” means from 50 to 70 degrees, and preferably from 55 to 65 degrees). The ordered array of microdomains, although exemplified here by assuming a hexagonal lattice-like pattern, is not limited to this arrangement. For example, there are also cases in which the ordered array of microdomains assumes a square arrangement. Nor are the cylindrical microdomains 12 limited to being arranged in an ordered pattern; cases in which the cylindrical microdomains 12 are arranged in a non-ordered pattern are also encompassed by the invention.

The size (diameter) of the cylindrical microdomains 12 may be suitably controlled by, for example, the molecular weight of the block copolymer used, and is preferably from 5 to 200 nm, and more preferably from 10 to 100 nm. If the cylindrical microdomains 12 have a shape that is elliptical, for example, the greatest outside diameter of the ellipse should fall within the above range. The distance between mutually neighboring microdomains (distance between the center axes) may be suitably controlled by means of, for example, the molecular weight of the block copolymer used, and is preferably from 5 to 300 nm, and more preferably from 10 to 150 nm. The size of the microdomains and the distance between the microdomains can be measured by examination with an atomic force microscope or the like. The term ‘microdomain’ is commonly used to denote the domains in a multiblock copolymer, and is not intended here to specify the size of the domains.

The cylindrical microdomains 12 are oriented perpendicularly to the substrate, and are preferably substantially perpendicular. The expression ‘substantially perpendicular’ here denotes that the center axes of the cylindrical microdomains 12 are inclined to the normal of the substrate at an angle of not more than ±45°, and preferably not more than ±30°. The angle of inclination can be measured by the TEM analysis of ultrathin sections, small-angle x-ray diffraction analysis or some other suitable technique.

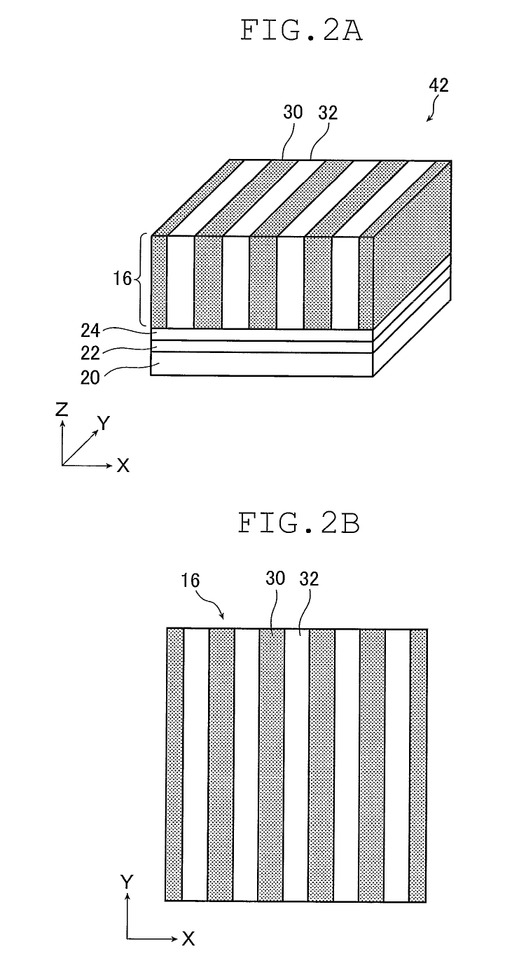

Next, FIG. 2 shows a schematic diagram of a structural body having a lamellar microphase-separated morphology obtained using a diblock copolymer (in which polymer A and polymer B are bonded together at the ends). “Lamellar microphase-separated morphology” refers herein to a structure in which one phase is lamellar. It should be noted that the flexible substrate 20, the metal oxide layer 22, and the layer 24 formed with a silane coupling agent are not limited to the relative thicknesses shown in FIG. 2. As shown in FIG. 2, the lamellar phases are alternately disposed. The lamellar phases 30 and 32 are formed of, respectively, the polymer A and the polymer B which make up the block copolymer. The lamellar phases are oriented substantially perpendicular to the flexible substrate 20 in the Z-axis direction in FIG. 2A. The invention is not limited to cases in which the lamellar phases are arranged in an ordered pattern; cases in which the lamellar phases are arranged, in part, in a non-ordered pattern are also encompassed by the invention.

The width of the lamellar phases may be suitably controlled by, for example, the molecular weight of the block copolymer used, and is preferably from 5 to 200 nm, and more preferably from 10 to 100 nm. The width of the lamellar phases can be measured by, for example, examination with an atomic force microscope.

The lamellar phases are oriented perpendicularly to the substrate, and are preferably substantially perpendicular. The expression ‘substantially perpendicular’ here means that the interfaces between the lamellar phases in the Z-axis direction in FIG. 2 are inclined to the normal of the substrate at an angle of not more than ±45°, and preferably not more than ±30°. The angle of inclination can be measured by the TEM analysis of ultrathin sections, small-angle x-ray diffraction analysis, or some other suitable technique.

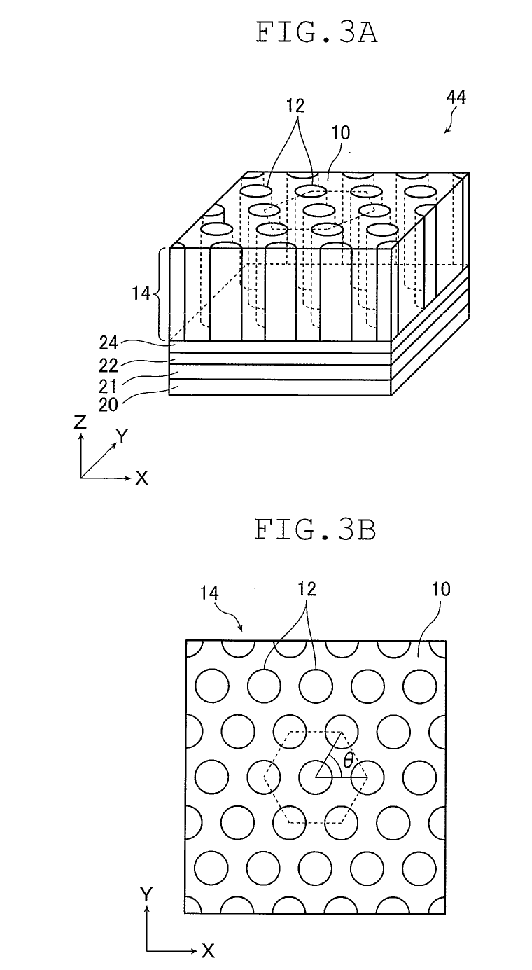

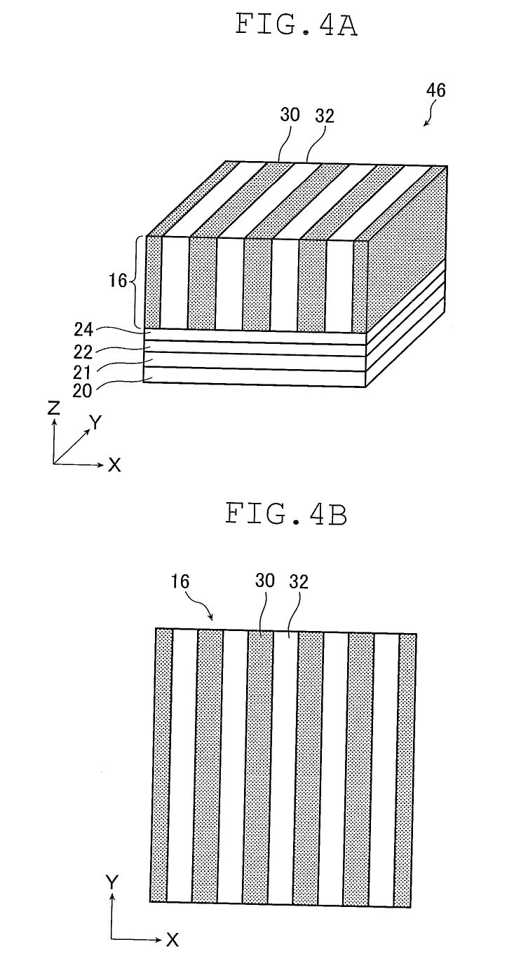

As explained above, the metal oxide layer in the structural body (multilayer body) of the invention may be in the form of a layered structure with a metal layer. FIGS. 3 and 4 are schematic diagrams showing other embodiments of the structural body (multilayer body) of the invention in which the metal oxide layer takes the form of a layered structure with a metal layer.

The structural bodies (multilayer bodies) of the invention shown in FIGS. 3 and 4 have a layered structure in which a flexible substrate 20, a metal layer 21, a metal oxide layer 22, a layer formed with a silane coupling agent 24, and block copolymer layers 14 and 16 are deposited in this order. Apart from having a metal layer 21, the inventive structural bodies (multilayer bodies) shown in FIGS. 3 and 4 are each constructed in the same way as the structural bodies of the invention shown in FIGS. 1 and 2.

The specific shape of the structural body (multilayer body) obtained by the invention is not subject to any particular limitation; a suitable and optimal shape may be selected according to the intended purpose. A film-like shape having a thickness of from 0.05 to 500 μm is preferred.

In the layered structural body obtained by the above-described manufacturing steps, because the substrate is a flexible substrate, the structural body itself has ample flexibility, providing considerable potential for use in a broad range of fields and applications. Examples of possible applications include photomasks, anisotropic electrically conductive films, anisotropic ion-conductive films, photonic crystals, phase shift films, polarizing films, screens, color filters, components for electronic displays, photoelectric conversion elements, nanoimprint molds, magnetic recording media, acoustic vibration materials, sound-absorbing materials and vibration-damping materials. Use in photomasks, anisotropic electrically conductive films, anisotropic ion-conductive films, photonic crystals, phase shift films and polarizing films is especially promising.

A porous body having nanosize pores can be obtained by removing the polymer chains within one of the phases in the lamellar or cylindrical microphase-separated morphology that forms within the block copolymer layer of the above-described layered structural body. In particular, by dissolving only the cylindrical microdomain 12 portions shown in FIG. 1, nanosize cylindrical throughholes can be created in the block copolymer layer.

Removal may be carried out using, without particular limitation, any suitable method known to the art. Illustrative examples of methods for decomposing and removing one of the phases (decomposition step) include ion beam etching, ozonolysis treatment, UV irradiation and deep-UV irradiation. Use is made of a method and conditions which are suitable and optimal for the polymer material to be decomposed. Of the above, UV irradiation and deep-UV irradiation are preferred. The source of the ultraviolet light may be, for example, a high-pressure mercury vapor lamp or an electrodeless lamp. The illuminance of the UV light, while not subject to any particular limitation, is preferably from 10 to 300 mW. The total dose of UV light is preferably from 1 to 50 J/cm². It is also possible to use other methods of decomposition and removal, such as thermal decomposition of the polymer material by heating the polymer material to be decomposed to a temperature at or above its thermal decomposition temperature.

Following the above removal by decomposition, a washing step with a suitable solvent (e.g., acetic acid, methanol, water) may be carried out. The size of the pores obtained by the above method corresponds to the size of the above-described cylindrical microdomains or the lamellar phases.

The resulting porous body having nanosize pores can be applied to diverse applications. Examples of such applications include electronic information recording media, adsorbents, nanoscale reaction site membranes, separation membranes, and polarizing plate-protecting films in liquid-crystal displays and plasma displays.

In the present invention, by providing a metal oxide layer, a layer formed with a silane coupling agent (silane coupling agent layer) and a block copolymer layer on a flexible substrate, there can be obtained, at high definition and low cost, a micropattern morphology on a flexible substrate, and more particularly a microphase-separated morphology oriented perpendicular to the substrate. Attempts have hitherto been made to create perpendicularly oriented cylindrical microphase-separated morphologies on a silicon wafer (see, for example, B. H. Sohn et al. Polymer 43, 2507-2512 (2002)). However, the microphase-separated morphologies obtained have not been sufficiently ordered. Moreover, production over large surface areas on substrates such as silicon wafers has been impossible and the substrate itself has been rigid, thus limiting applications and resulting in poor practical utility. By contrast, the present invention uses a flexible substrate such as a polymer substrate and obtains a structural body have a micropattern over a large surface area and at low cost, enabling the development of various applications able to make the most of such flexibility. Moreover, block copolymers composed of general-purpose polymers can be used, which is industrially highly beneficial. Although the mechanism for the orientation of the microphase-separated morphology of the block copolymer has yet to be sufficiently elucidated in the literature and the detailed mechanism of operation of the present invention is not well understood, it is presumed that the use of a metal oxide layer and a layer formed with a silane coupling agent make it possible to obtain substrate surface qualities (surface energy, surface roughness) suitable for perpendicular orientation.

### EXAMPLES

Examples of the invention are provided below by way of illustration and not by way of limitation.

Contact angle measurements in the following examples were carried out by depositing a 2 μL drop of ion-exchanged water on the film and measuring the water drop contact angle on the film surface 10 seconds later with a contact angle goniometer (DropMaster 700, manufactured by Kyowa Interface Science Co., Ltd.). Atomic force microscope (AFM) observations were carried out with a SPA-400 system (Seiko Instruments, Inc.), on the basis of which values such as the subsequently described surface roughness were measured. Scanning transmission electron microscope (STEM) observations were carried out using an HD-2300 system (Hitachi High-Technologies Corporation).

### Example 1

A SiO₂ layer (thickness, 50 nm) was formed by vapor-depositing SiO onto a polyimide (PI) film (Upilex-50S; Ube Industries, Ltd.) in an oxygen atmosphere. The surface roughness of the SiO₂ layer was 0.91 nm. Following vapor deposition, the film was immediately immersed in a 1.0 wt % toluene solution of octadecyltrimethoxysilane (Gelest, Inc.) and left at rest for one day. The film was then rinsed with toluene and dried, thereby creating a surface-modified polymer substrate 1 on which a layer formed with a silane coupling agent had also been deposited. The layer formed with the silane coupling agent was a monomolecular layer. Assuming the thickness of this layer to be about the chain length of one molecule of the silane coupling agent, from calculations with WinMOPAC (Ver. 3.9.0), the layer thickness was estimated to be about 2.6 nm. Following surface modification, the contact angle with water was 97±6°. The difference between the surface tension of polystyrene (PS) with the substrate and the surface tension of polymethyl methacrylate (PMMA) with the substrate was 0.26 mN/m.

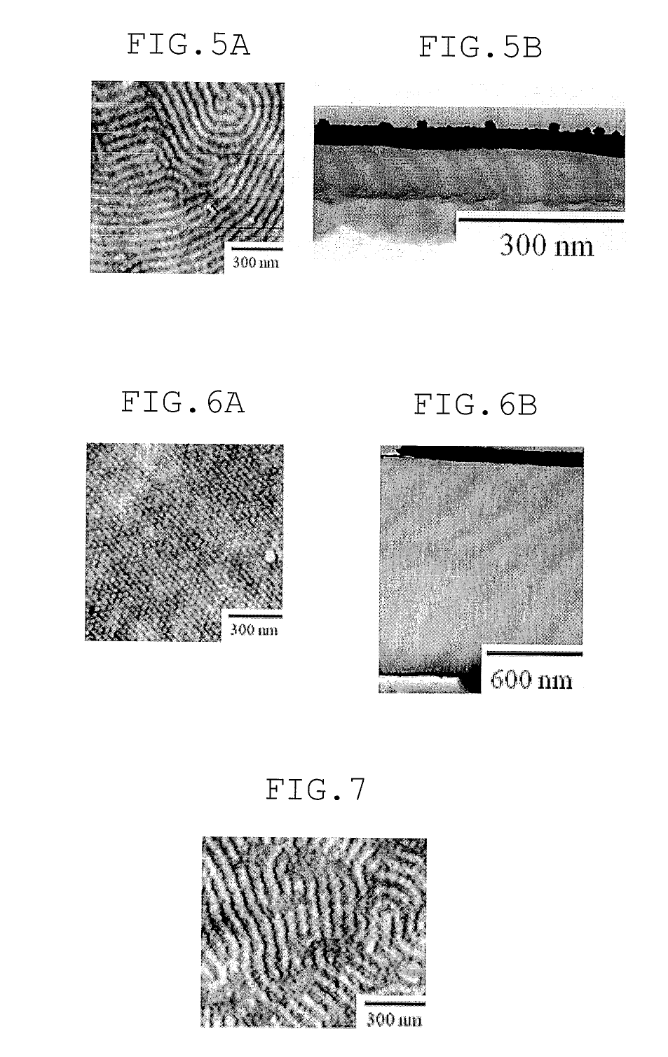

A 2.50 wt % toluene solution of PS-b-PMMA (available from Polymer Source, Inc.; Mw of PS=37,000; Mw of PMMA=37,000) was spin-coated (slope, 5 seconds; 3,000 rpm, 90 seconds) onto the above substrate 1. Here, “slope 5 seconds” signifies the length of time until the spin rate reaches 3,000 rpm. Next, annealing was carried out at 200° C. in a N₂ atmosphere, thereby forming a block copolymer layer (layer thickness, 100 nm). The resulting product was called Specimen A. FIG. 5A shows a surface AFM image of Specimen A. In addition, using a method like that described in the literature (Polymer 43, 2507 (2002)), a platinum thin-film was formed on Specimen A by sputtering, following which Specimen A was encapsulated with an epoxy resin and cut with a microtome to form ultrathin sections. The sections were then dyed with RuO₄ and the structure in the layer depth direction was examined by carrying out TEM analysis (FIG. 5B). It was confirmed from FIGS. 5A and B that a perpendicular lamellar phase-separated morphology in which lamellar microdomains are perpendicularly oriented had formed in the block copolymer layer.

### Example 2

A SiO₂ layer was formed by vapor-depositing SiO onto a polyimide (PI) film (Upilex-50S; Ube Industries, Ltd.) in an oxygen atmosphere. The surface roughness of the SiO₂ layer was 0.91 nm. Following vapor deposition, the film was immediately immersed in a 1.0 wt % toluene solution of methoxyphenylpropylmethyldichlorosilane (Gelest, Inc.) and left at rest for one day. The film was then rinsed with toluene and dried, thereby creating a surface-modified polymer substrate 2 on which a layer formed with a silane coupling agent had also been deposited. The layer formed with the silane coupling agent had a thickness, determined by the method described in Example 1 above, of about 1.3 nm. Following surface modification, the contact angle with water was 81±6°. The difference between the surface tension of polystyrene (PS) with the substrate and the surface tension of polymethyl methacrylate (PMMA) with the substrate was 0.1 mN/m.

A 10.0 wt % toluene solution of PS-b-PMMA (available from Polymer Source, Inc.; Mw of PS=35,500; Mw of PMMA=12,200) was spin-coated (slope, 5 seconds; 3,000 rpm, 90 seconds) onto the above substrate 2. Next, annealing was carried out at 200° C. in a vacuum, thereby forming a block copolymer layer (layer thickness, 1,000 nm). The resulting product was called Specimen B. FIG. 6A shows a surface AFM image of Specimen B. FIG. 6B shows a TEM image of an ultrathin section created by the method described in Example 1 above. It was confirmed from FIGS. 6A and B that a perpendicular cylindrical phase-separated morphology in which cylindrical microdomains are perpendicularly oriented had formed in the block copolymer layer.

### Example 3

A copper layer (thickness, 50 nm) was created by electron beam (EB) vapor-depositing copper onto a polyimide (PI) film (Upilex-50S; Ube Industries, Ltd.) in a vacuum. The film was taken out into the open air, and the surface roughness was measured and found to be 1.08 nm. The film was left to stand out in the open air overnight to allow the surface to oxidize, following which the film was immersed in a 1.0 wt % toluene solution of octadecyltrimethoxysilane (Gelest, Inc.) and left at rest for one day. The film was then rinsed with toluene and dried, thereby creating a surface-modified polymer substrate 3 on which a layer formed with a silane coupling agent had also been deposited. The layer formed with the silane coupling agent had a thickness, determined by the method described in Example 1 above, of about 2.6 nm. Following vapor deposition, the contact angle with water was 21±4°. Following surface modification, the contact angle with water was 107±10°. The difference between the surface tension of polystyrene (PS) with the substrate and the surface tension of polymethyl methacrylate (PMMA) with the substrate was 0.26 mN/m.

Next, a 2.50 wt % toluene solution of PS-b-PMMA (available from Polymer Source, Inc.; Mw of PS=37,000; Mw of PMMA=37,000) was spin-coated (1,500 rpm, 30 seconds) onto the above substrate 3 Annealing was then carried out at 200° C. in a N₂ atmosphere, thereby creating a block copolymer layer (layer thickness, 100 nm). The resulting product was called Specimen C. FIG. 7 shows a surface AFM image of Specimen C. It was confirmed from the surface AFM image in FIG. 7 and from TEM examination carried out by the same method as in Example 1 that a perpendicular lamellar phase-separated morphology in which lamellar microdomains are perpendicularly oriented had formed in the block copolymer layer.

### Example 4

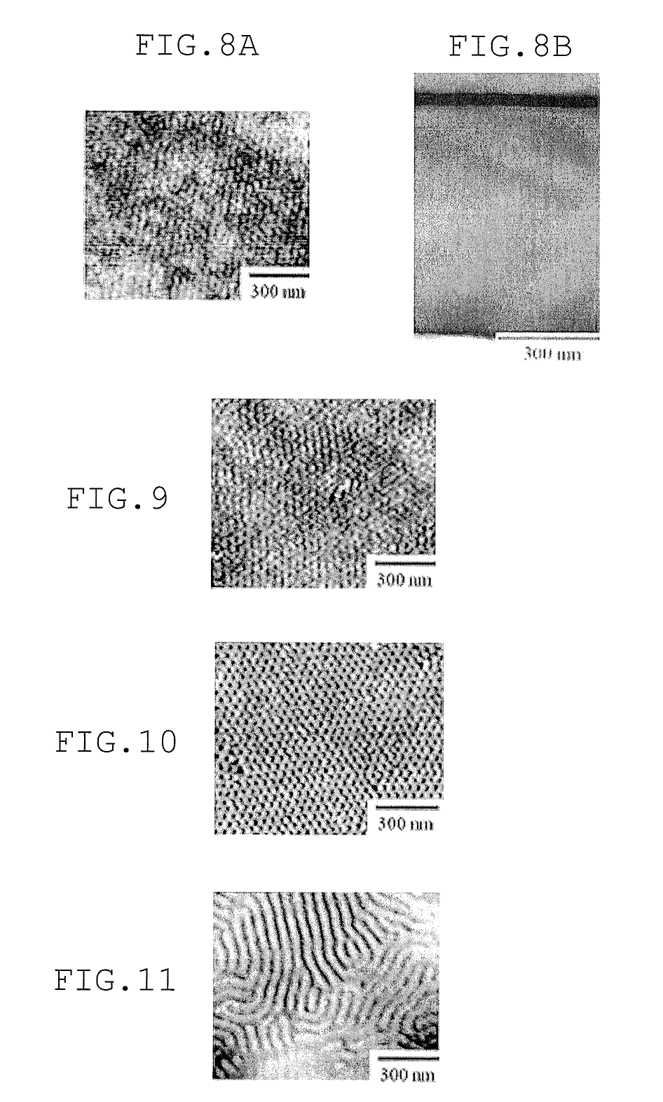

A 10.0 wt % toluene solution of PS-b-PMMA (available from Polymer Source, Inc.; Mw of PS=35,500; Mw of PMMA=12,200) was spin-coated (1,500 rpm, 30 seconds) onto the surface-modified polymer substrate 1 prepared in Example 1. Next, annealing was carried out at 220° C. in an N₂ atmosphere, thereby creating a block copolymer layer (layer thickness, 700 nm). The resulting product was called Specimen D. FIG. 8A shows a surface AFM image of Specimen D. TEM examination was carried out by the same method as in Example 1 on Specimen D as well (FIG. 8B). It was confirmed from FIGS. 8A and B that a perpendicular cylindrical phase-separated morphology in which cylindrical microdomains are perpendicularly oriented had formed in the block copolymer layer.

### Example 5

Copper was electron beam (EB) vapor-deposited to a thickness of 50 nm onto a PI film in the same way as in Example 1. Following vapor deposition, the surface roughness was measured and found to be 1.08 nm. The film was left in the open air overnight to allow the surface to oxidize, following which the film was immersed in a 0.5 wt % toluene solution of methoxyphenylpropyltrimethoxysilane and left at rest for one day. The film was then rinsed with toluene and dried, thereby creating a surface-modified polymer substrate 4 on which a layer formed with a silane coupling agent had also been deposited. The layer formed with the silane coupling agent had a thickness, determined by the method described in Example 1 above, of about 1.3 nm. Following surface modification, the contact angle with water was 75±12°. The difference between the surface tension of polystyrene (PS) with the substrate and the surface tension of polymethyl methacrylate (PMMA) with the substrate was 0.1 mN/m.

Next, a 3.50 wt % toluene solution of PS-b-PMMA (Mw of PS=35,500; Mw of PMMA=12,200) was spin-coated (1,500 rpm, 30 seconds) onto the above substrate 4. Annealing was then carried out at 200° C. in a N₂ atmosphere, thereby creating a block copolymer layer (layer thickness, 160 nm). The resulting product was called Specimen E. FIG. 9 shows a surface AFM image of Specimen E. It was confirmed from the surface AFM image in FIG. 9 and from TEM examination carried out by the same method as in Example 1 that a perpendicular cylindrical phase-separated morphology in which cylindrical microdomains are perpendicularly oriented had formed in the block copolymer layer.

### Example 6

Specimen E obtained in Example 5 was subjected to UV irradiation (25 J/cm²), then rinsed with acetic acid to remove the PMMA component. The resulting product was called Specimen F. FIG. 10 shows a surface AFM image of Specimen F. From FIG. 10, it was confirmed that the PMMA component had been removed and that cylindrical pores had been formed in the block copolymer layer.

### Example 7

Indium-tin oxide (ITO) was sputtered to a thickness of 50 nm onto a PEN film (Teijin Ltd.). Following sputtering, the surface roughness was measured and found to be 1.07 nm. The film was then immersed in a 1.0 wt % toluene solution of octadecyltrimethoxysilane and left at rest for one day. The film was then rinsed with toluene and dried, thereby creating a surface-modified polymer substrate 5 on which a layer formed with a silane coupling agent had also been deposited. The layer formed with the silane coupling agent had a thickness, determined by the same method as in Example 1 above, of about 2.6 nm. Following surface modification, the contact angle was 94±11°. The difference between the surface tension of polystyrene (PS) with the substrate and the surface tension of polymethyl methacrylate (PMMA) with the substrate was 0.26 mN/m.

Next, a 2.50 wt % toluene solution of PS-b-PMMA (Mw of PS=37,000; Mw of PMMA=37,000) was spin-coated (1,500 rpm, 30 seconds) onto the above substrate 5. Annealing was then carried out at 200° C. in a N₂ atmosphere, thereby forming a block copolymer layer (layer thickness, 100 nm). The resulting product was called Specimen G. FIG. 11 shows a surface AFM image of Specimen G. It was confirmed from the surface AFM image in FIG. 11 and from TEM examination carried out by the same method as in Example 1 that a perpendicular lamellar phase-separated morphology in which lamellar microdomains are perpendicularly oriented had formed in the block copolymer layer.

### Example 8

Copper was electron beam (EB) vapor-deposited to a thickness of 50 nm onto a PI film. Following vapor deposition, SiO was vapor-deposited in an oxygen atmosphere, thereby forming also a SiO₂ layer (thickness, 50 nm). The surface roughness of the SiO₂ layer was 0.93 nm. The film was then immersed in a 0.50 wt % toluene solution of methoxyphenylpropyltrimethoxysilane and left at rest for one day. The film was then rinsed with toluene and dried, thereby creating a surface-modified polymer substrate 6 on which a layer formed with a silane coupling agent had also been deposited. The layer formed with the silane coupling agent had a thickness, determined by the same method as in Example 1 above, of about 1.3 nm. Following surface modification, the contact angle was 74±11°. The difference between the surface tension of polystyrene (PS) with the substrate and the surface tension of polymethyl methacrylate (PMMA) with the substrate was 0.1 mN/m.

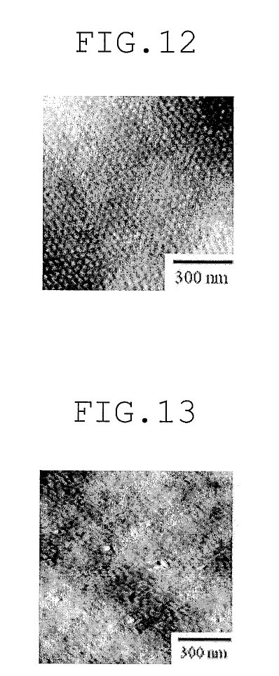

Next, a 10.0 wt % toluene solution of PS-b-PMMA (Mw of PS=35,500; Mw of PMMA=12,200) was spin-coated (1,500 rpm, 30 seconds) onto the above substrate 6. Annealing was then carried out at 220° C. in a N₂ atmosphere, thereby creating a block copolymer layer (layer thickness, 120 nm). The resulting product was called Specimen H. FIG. 12 shows a surface AFM image of Specimen H. It was confirmed from the surface AFM image in FIG. 12 and from TEM examination carried out by the same method as in Example 1 that a perpendicular cylindrical phase-separated morphology in which cylindrical microdomains are perpendicularly oriented had formed in the block copolymer layer.

### Comparative Example 1

Aside from the absence of a layer formed with a silane coupling agent, a Specimen I was fabricated in the same way as the method used to fabricate Specimen A. The results of surface AFM analysis showed that a perpendicular lamellar structure had not formed in Specimen I.

### Comparative Example 2

A quartz substrate (Matsunami Glass Industries, Ltd.; surface roughness, 0.23 nm) was immersed for one day in a 1% toluene solution of 3-methacryloxypropyltrimethoxysilane (Gelest, Inc.). The substrate was then rinsed with toluene and dried, thereby producing a surface-modified quartz substrate on which a layer formed with a silane coupling agent had been deposited. The layer formed with the silane coupling agent had a thickness, determined by the same method as in Example 1, of about 0.97 nm. Following surface modification, the contact angle was 61±6°. The difference between the surface tension of polystyrene (PS) with the substrate and the surface tension of polymethyl methacrylate (PMMA) with the substrate was 11 mN/m.

A 2.5 wt % toluene solution of PS-b-PMMA (available from Polymer Source, Inc.; Mw of PS=37,000; Mw of PMMA=37,000) was spin-coated (slope, 5 seconds; 3,000 rpm, 90 seconds) onto the quartz substrate. Next, annealing was carried out at 200° C. in a vacuum, thereby forming a block copolymer layer (layer thickness, 100 nm). The resulting product was called Specimen J. FIG. 13 shows a surface AFM image of Specimen J, from which it is apparent that a perpendicular lamellar structure was not obtained in Specimen J.

What is claimed is:

1. A structure comprising:
a flexible substrate and, in order thereon,
a metal oxide layer,
a layer formed with a silane coupling agent, and
a layer which has a microphase-separated morphology and is formed of a block copolymer obtained by bonding two or more mutually incompatible polymer chains;
wherein the microphase-separated morphology has one phase which is lamellar or cylindrical, and oriented perpendicularly to the substrate.

2. The structure of claim 1, wherein the layer formed with the silane coupling agent has a film thickness which is at least equal to a surface roughness of the metal oxide layer.

3. The structure of claim 1, wherein the silane coupling agent has general formula (1) below 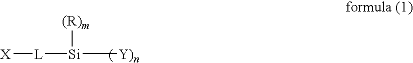
where X is a functional group,
L is a linkage group or merely a bond,
R is a hydrogen atom or an alkyl of 1 to 6 carbons,
Y is a hydrolyzable group, and
the letter m is an integer from 0 to 2 and the letter n is an integer from 1 to 3, such that n+m=3.

4. The structure of claim 1, wherein the metal oxide layer is composed of an oxide of a metal selected from the group consisting of silicon, aluminum, silver, copper, iron, nickel, lead, indium, chromium, tin, titanium, zinc, gallium, bismuth and zirconium.

5. A method of manufacturing the structure of claim 1, comprising the steps of:
forming a metal oxide layer on a flexible substrate;
forming a layer with a silane coupling agent on the metal oxide layer; and
forming a block copolymer layer on the layer formed with the silane coupling agent.
